(19) United States
(12) Patent Application Publication
(10) Pub. No.: US 2009/0211385 A1
(43) Pub. Date: Aug. 27, 2009

(54) ADJUSTING DEVICE, ESPECIALL FOR A HELMET

(75) Inventors: Alexandre FIQUEPRON, Lille (FR); Julien Laine, Marcq en Baroeul (FR)

Correspondence Address: KENYON & KENYON LLP, 1500 K STREET N.W., SUITE 700, WASHINGTON, DC, 20005, US

(73) Assignee: DECATHLON, Villeneuve D'Ascq (FR)

(21) Appl. No.: 12/391,819

(22) Filed: Feb. 24, 2009

(30) Foreign Application Priority Data
Feb. 27, 2008 (FR) 08/51257

(51) Int. Cl. F16H 55/26

(52) U.S. Cl. 74/422

(57) ABSTRACT

The invention relates to an adjusting device for adjustment of a dimension of an object, applying especially to adjustment of a dimension of an object intended to be worn by a user, such as a helmet. The device comprises a pinion with first teeth, free in rotation about an axis in a housing, and a rack provided with a row of second teeth, slid freely in translation into the housing. The second teeth cooperate with the first teeth so that rotation of the pinion causes translation of the rack. The rack is deformable elastically, such that when a force is exerted on it in the direction opposite the direction of translation during rotation of the pinion, it undergoes elastic deformation. The housing leaves clearance for the rack, in the plane of rotation of the pinion and perpendicular to the direction of translation, at least equal to the least of the heights of the first and second teeth, such that when the rack undergoes elastic deformation, that of the second teeth in cooperation with the first teeth disengages from the latter.

The object of the present invention is an adjusting device for adjusting at least one dimension of an object. It especially applies to adjusting a dimension of an object intended to be worn by a user, such as a helmet. More generally, the invention applies to the adjustment of a dimension of any object intended to be worn by a user, such as clothing, a shoe, or even an accessory. It can also be any object at all, not necessarily intended to be worn by a user, though having at least one adjustable dimension. In particular, it can be a strap or a clamping cable, used alone or attached to an object of adjustable dimension.

Adjusting devices intended in particular for adjusting a helmet to the head girth of a user are known, for example from documents U.S. Pat. No. 7,222,374, US 2007/0266481 and WO 98/46097.

Such devices generally comprise a system associating a pinion provided with several teeth and housed free in rotation in a housing with one or two racks provided with a row of teeth. The racks are slid free in translation into the housing. The teeth of the racks cooperate with the teeth of the pinion, such that the rotation of this pinion causes the translation of the racks.

A button or an adjusting thumb wheel can optionally be mounted connected in rotation to the pinion, to allow the user to set this pinion in rotation.

The racks are themselves connected to a system for adjusting the head girth, for example a strap placed to slide inside the helmet and forming a closed loop. Thus, translation of the racks in one direction or the other causes a decrease or increase in the perimeter of the loop, and thus adjustment of the helmet to the head girth of the user (in other words, clamping or unclamping of the helmet).

One of the problems raised by this type of adjusting device is that when adjustment (clamping) is forced beyond the optimum adjustment position, that is, when the perimeter of the loop is below the head girth of the user, a constraint is made on the device in the form of a force which pulls on the racks in the direction opposite the clamping translation.

The result of this is effort exerted on the teeth of the pinion and or of the racks, which can cause damage to these teeth or to the linking means between the adjusting thumb wheel and the pinion. In certain cases, the teeth or these linking means can even break if the effort is excessive.

The problem here is thus to provide an adjusting device, especially for adjustment of a helmet to the head girth of a user, based on a pinion-rack system such as presented hereinabove, which does not risk being damaged when forced onto the device beyond the optimum adjustment position.

The object of the invention is thus to provide a solution to the above problem among other problems.

According to a first aspect, the invention thus relates to an adjusting device suitable for adjusting at least one dimension of an object.

The object can be for example an object intended to be worn by a user, such as a shoe, an item of clothing, a helmet or an accessory.

The device comprises a pinion provided with several first teeth of a first height. This pinion is housed free in rotation about an axis in a housing.

The expression “housed free in rotation” is understood to mean that, once housed in the housing, the pinion can turn about the axis. Nevertheless, this rotation can be controlled by temporary blocking/unblocking means, to be explained later in this description.

Also, when it comes to the height of a tooth, this refers to the distance between the point and the base of this tooth.

The device likewise comprises at least one first rack provided with at least one row of several second teeth of a second height. This second tooth height can equally be equal or different to the first tooth height.

This first rack is slid free in translation in the housing.

The second teeth, that is, the teeth of the first rack, cooperate with the first teeth, that is, the teeth of the pinion, such that rotation of the pinion about the axis causes translation of the first rack.

Characteristically, the first rack is deformable elastically such that when a force acts on this first rack in the direction opposite the direction of the translation during rotation of the pinion, the first rack undergoes elastic deformation.

In addition, the housing leaves a clearance for the first rack, in the plane of rotation of the pinion and perpendicular to the direction of translation. This clearance is at least equal to the least of the tooth heights, between the first height, that is, the height of the first teeth of the pinion, and the second height, that is, the height of the second teeth of the first rack.

In this way, when the first rack undergoes elastic deformation, that of the second teeth in cooperation with the first teeth of the pinion disengages from these first teeth.

Accordingly, when the adjustment (clamping) is forced beyond the optimum adjustment position, the constraint exerted on the device takes the form of a force which pulls on the racks in the direction opposite the clamping translation.

Under the effect of this force, and due to the presence of the clearance in the housing, the rack deforms elastically and its tooth, among the second teeth, which was cooperating with the teeth of the pinion, or first teeth, disengages from this pinion.

In this way, the effort on the teeth of the rack and of the pinion ceases, and the rack reverses, that is, in the direction opposite the clamping translation, causing unclamping, thus a return to an optimum adjustment position, or, at least, to an adjustment position exerting no damageable constraint on the device.

In a first variant, the device comprises a second rack provided with at least one row of several third teeth of a third height. This second rack is slid, free in translation opposite the translation of the first rack, into the housing.

These third teeth cooperate with the first teeth such that rotation of the pinion about the axis causes translation of the second rack.

This second rack is deformable elastically, such that when a force acts on this second rack in the direction opposite the direction of the translation during rotation of the pinion, this second rack undergoes elastic deformation.

Also, the housing leaves a clearance for the second rack, in the plane of rotation of the pinion and perpendicular to the direction of translation.

This clearance is at least equal to the least of the heights of the tooth, between the first height, that is, the height of the first teeth of the pinion, and the third height, that is, the height of the third teeth of the second rack.

In this way, when the second rack undergoes this elastic deformation, that of the third teeth in cooperation with the first teeth of the pinion disengages from these first teeth.

The property according to which the first and/or the second rack are deformable elastically can derive from the material used, for example plastic material such as polypropylene or TPU, and/or can derive from the structure itself. Even with material reputed to be less deformable, such as metal, the rack could be sufficiently deformable elastically if its structure is sufficiently fine.

The pinion will generally likewise be made of plastic materials like polycarbonate, or polyacetate.

In a variant, optionally in combination with the preceding, the first and/or second rack is in the form of a longitudinal element provided with an opening according to its longitudinal direction.

This opening is delimited by a first side, along which is placed the row of second and/or third teeth.

In another variant, optionally in combination with one or more of any of the preceding, the housing comprises a cavity centred on the axis of rotation of the pinion. This cavity is intended to receive the pinion.

Also, the housing likewise comprises two longitudinal parts on either side of the cavity. These two longitudinal parts are designed to guide the first and/or second rack in translation.

These two longitudinal parts each have a first and a second passage for the passage of the first and/or second rack. The first passages are placed at a distance from the cavity, and the second passages terminate in the cavity.

The distance between the axis of rotation of the pinion and the second passages, that is, the passages terminating in the cavity, is less than the minimal distance between this axis of rotation and the end of the first and/or second rack.

This minimal distance generally corresponds to an end position of the rack in which the longitudinal element is stopped, at the level of the end of the opening, against the teeth of the pinion.

As a consequence, this minimal distance corresponds to the radius of the pinion (height of the teeth included) augmented by the distance between the end of the opening in the longitudinal element and the end of this longitudinal element.

If it is considered that the longitudinal element comprises a first part inside of which is formed the opening, thus a recessed first part, and a full second part in its end, then the distance between the end of the opening and the end of the longitudinal element corresponds to the length of this second full part.

Accordingly, the minimal distance described hereinabove corresponds to the radius of the pinion (height of the teeth included) augmented by the length of this full end part of the longitudinal element forming the rack.

As a consequence, in this end position, if the distance between the axis of rotation of the pinion and the second passages is such as presented above, the end of the rack remains in the housing guided through at least the second passage. Accordingly, the rack remains in the plane of rotation of the pinion, and does not exit the housing.

In yet another variant, optionally in combination with any one of the preceding, the base of the housing, for example the base of the cavity, has at least one stud against which the first and/or second rack can rest, so as to limit deformation of the first and/or second rack in the plane of rotation of the pinion.

In yet another variant, optionally in combination with any one of the preceding, the device comprises a thumb wheel connected in rotation to the pinion by linking means and intended to impart rotation to the pinion.

The pinion can be directly integrated into the thumb wheel.

This thumb wheel can optionally form a closing cap of the housing.

In yet another variant, optionally in combination with any one of the preceding, the pinion is mounted on a support which is housed in the housing.

In this variant, the support is preferably provided with temporary blocking means which cooperate with temporary blocking means in the housing, so as to temporarily prevent free rotation of the pinion.

Even more preferably, the temporary blocking means of the support comprise at least one deformable and preferably semi-circular lateral branch provided with a pin. On the other hand, the temporary blocking means in the housing comprise striae arranged in a crown and which cooperate with the pin.

In this way, in the absence of a certain force of rotation imparted in one direction or the other to the thumb wheel, the pin of the lateral branch of the support of the pinion remains blocked temporarily in one of the striae of the crown of striae of the housing. The pinion does not enter rotation, and the rack is stable.

To adjust the device, rotation must be imparted to the thumb wheel, with a certain force, the effect of which is to impart this same rotation to the support of the pinion. The pin then leaves the stria in which it was blocked temporarily, under the effect of elastic deformation of the lateral branch bearing this pin.

If rotation continues, with at least this same force, the pin successively penetrates several striae of the housing, by the return effect of the deformable lateral branch, but immediately comes out of these striae, in the manner of a latch.

Rotation is thus triggered, causing translation of the rack, until the force of rotation imparted to the thumb wheel drops below a certain threshold. Below this threshold, the pin re-engages in one of the striae of the crown of striae of the housing, though this time without coming out of the latter, under the return effect of the deformable lateral branch. The pin is thus blocked again temporarily, stabilising the rack.

According to a second aspect, the invention likewise relates to an object having at least one adjustable dimension by means of adjustment means.

Characteristically, the adjustment means are connected to, or comprise, an adjusting device such as disclosed hereinabove, and translation of the first and/or second rack causes adjustment of the adjustable dimension of the object.

The adjustment means can comprise a strap or a cable connected to the object and whereof at least one first end is connected to, or constitutes, the first or second rack of the adjusting device.

A second end of the strap or of the cable is optionally connected to, or constitutes, the other of the first or second racks of the adjusting device.

In a variant, optionally in combination with the preceding, the object is intended to be worn by a user, such as for example a helmet, a shoe, an item of clothing or an accessory. Adjustment thus adapts the adjustable dimension of the object to the dimension or dimensions of the part of the body of the user intended to wear this object.

The object is optionally intended to be worn on the head of a user, such as a helmet for example. The adjustable dimension is thus the head girth.

Alternatively, the object is intended to be worn on the foot of a user, such as for example a shoe. The adjustable dimension is thus the ankle joint or the calf girth.

According to a third aspect, the invention further relates to a strap or clamping cable designed to form a closed loop and having a first and a second end.

The strap or the cable is characteristically provided with an adjusting device such as disclosed above. Also, its first and/or its second end is connected to, or constitutes, the first and/or second rack of the adjusting device. Translation of the first and/or second rack thus causes adjustment of the perimeter of the loop.

Other characteristics and advantages of the invention will emerge more clearly and fully from the following description of the preferred variant embodiments of the device, which are given by way of non-limiting examples and in reference to the following attached drawings.

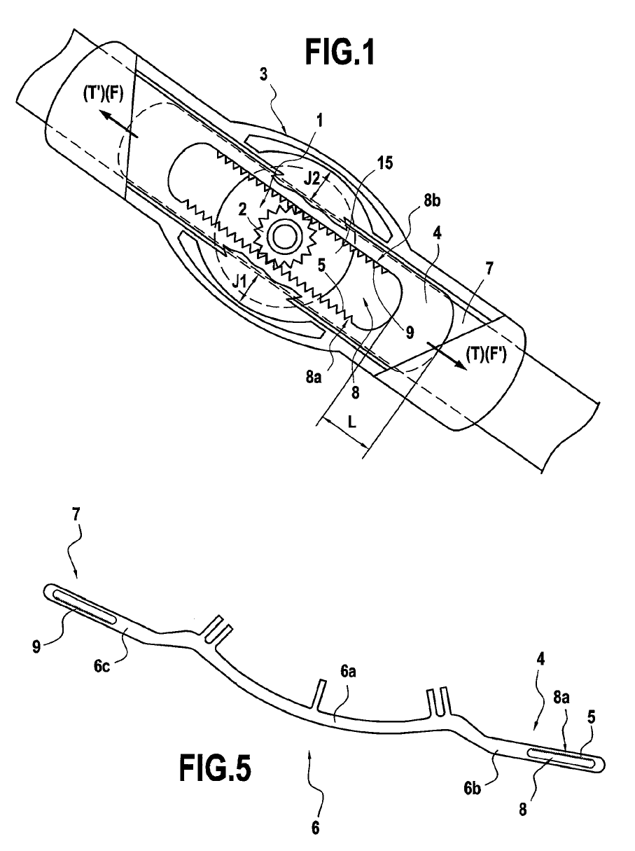

FIG. 1 schematically illustrates a variant of the device of the invention, viewed from below,

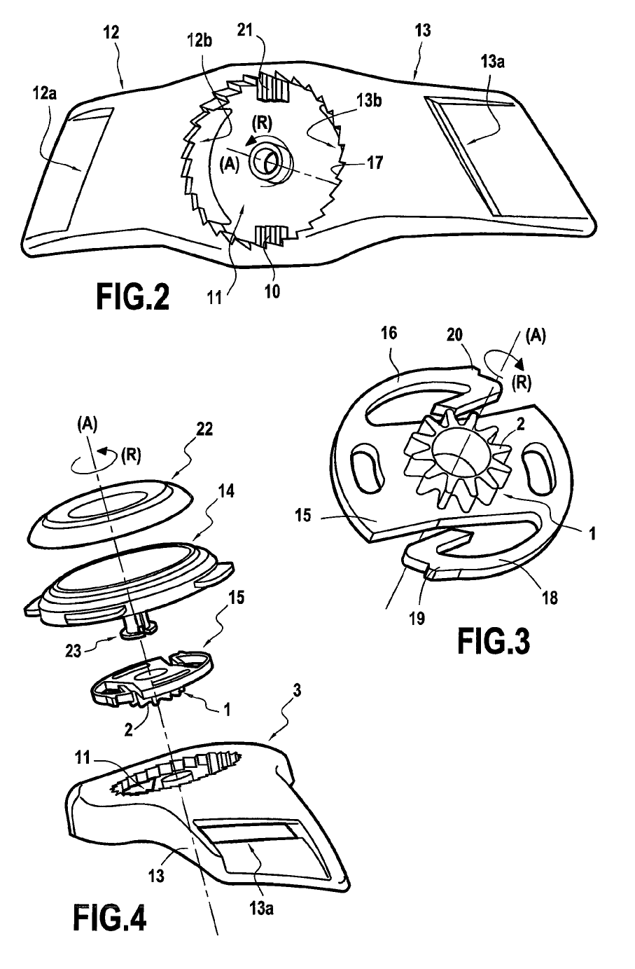

FIG. 2 schematically illustrates the housing of the device of the variant of FIG. 1, viewed from above,

FIG. 3 schematically illustrates the details of the pinion and its support of the device of FIG. 1,

FIG. 4 schematically illustrates an exploded view of the device of FIG. 1, without the racks,

FIG. 5 schematically illustrates the adjustment means of an object with adjustable dimension, in the variant in the form of a strap, especially for a helmet.

FIG. 1 illustrates the adjusting device of the invention in a variant embodiment.

In this variant, two racks 4, 7 are slid in the opposite direction in a housing 3, free in translation T or T′, so as to be compelled to cooperate with a pinion 1 housed free in rotation about its central axis in the housing 3.

In precise terms, the first teeth 2 of the pinion 1 cooperate with the row of second teeth 5 of the first rack 4, and with the row of third teeth 9 of the second rack 7.

Accordingly, rotation R of the pinion 1 about its central axis A (illustrated in FIG. 3) causes translation T of the first rack 4, and translation T′, in the inverse direction of T, of the second rack 7.

The first 4 and second 7 racks are deformable elastically, especially in the direction perpendicular to the direction of translation T, T′.

This first and this second rack 4, 7 are in the form of two longitudinal elements 4, 7 provided with an opening (referenced 8 in what relates to the first longitudinal element 4) according to their longitudinal direction which corresponds to the direction of translation T, T′. Only the opening 8 of the first rack 4 is referenced in FIG. 1, to the extent where the two first and second racks 4, 7 are superposed and thus where the two openings are likewise superposed.

The row of second teeth 5 of the first rack 4 is thus placed along one of the two edges or sides 8a, 8b of the opening 8, in this case the edge 8a.

The same applies for the row of third teeth 9 of the second rack 7, on an edge of the longitudinal opening of the longitudinal element 7 constituting this second rack opposite the edge 8a of the opening 8 along which are arranged the second teeth 5 of the first rack 4.

Accordingly, when a force F acts on the first rack 4, in the direction opposite the direction of translation T, thus in the direction of translation T′, during rotation of the pinion 1, the first rack 4 undergoes elastic deformation.

Similarly, when a force F′ acts on the second rack 7, in the direction opposite the direction of translation T′, thus in the direction of translation T, during rotation of the pinion 1, the second rack 7 undergoes elastic deformation.

These elastic deformations act perpendicularly to the direction of translation T, T′, due to rotation of the pinion 1, and thus tend to naturally shift the row of second teeth 5 of the first rack 4 and third teeth 9 of the second rack, so that these second and third teeth 5, 9 are no longer meshed with the first teeth 2 of the pinion 1.

The first and second racks 4 and 7 are certainly constrained to slide in translation T, T′ in the housing 3, but the latter has sufficient clearance jᵢ and clearance j₂, in the plane of rotation of the pinion 1 and perpendicular to the direction of translation T, T′, such that when the first rack 4, respectively the second rack 7 undergoes the abovementioned elastic deformation, the second tooth among the second teeth 5, respectively the third tooth among the third teeth 9, in cooperation with the first teeth 2 of the pinion 1, disengage from these first teeth 2 of the pinion 1.

To do this, the clearance jᵢ is greater than or equal to the least height between the height of the second teeth 5 (second height) of the first rack 4, and the height of the first teeth 2 (first height) of the pinion 1.

Also, the clearance j₂ is greater than or equal to the least height between the height of the third teeth 9 (third height) of the second rack 7, and the height of the first teeth 2 (first height) of the pinion 1.

The housing 3 of the device is illustrated in greater detail in FIG. 2. It comprises a cavity 11, preferably circular, centred on the axis of rotation of the pinion 1, and intended to receive this pinion 1.

The clearances jᵢ and j₂ mentioned hereinabove, and which are embodied in FIG. 1, thus each correspond to the distance between one of the longitudinal edges of one of the two racks 4, 7 and the edge of the cavity 11.

In precise terms, the clearance jᵢ corresponds to the distance between the longitudinal edge of the first rack 4, to the side of the second teeth 5 of this first rack 4, as far as the edge of the cavity 11.

Also, the clearance j₂ corresponds to the distance between the longitudinal edge of the second rack 7, to the side of the third teeth 9 of this second rack 7, as far as the edge of the cavity 11.

For the elastic deformation mentioned above to be able to take place, and thus disengagement of the teeth 5, 9 from the racks 4, 7, of the teeth 2 of the pinion 1, to be able to take place, the clearances jᵢ and j₂ must be greater than or equal to the least of the heights of the teeth, as explained earlier. Also, each of these clearances is at maximum equal respectively to j₁ and j₂ such as illustrated in FIG. 1, that is, maximum elastic deformation is limited by the edge of the cavity 11.

In addition, in the variant illustrated in FIGS. 1 and 2, the housing 3 comprises two longitudinal parts 12 and 13, distributed on either side of the cavity 11, and extending in the direction of translation T, T′. These two longitudinal parts 12, 13 are intended to guide in translation T, T′ each of the racks 4 and 7.

In precise terms, the first longitudinal part 12 has two passages 12a, 12b for passage of one of the two racks 4, 7 or both.

The second longitudinal part 13 likewise has two passages 13a, 13b for passage of one of the two racks 4, 7 or both.

The first passage 12a of the first longitudinal part 12 and the first passage 13a of the other longitudinal part 13, are placed at a distance from the cavity 11.

The second passage 12b of the first longitudinal part 12 and the second passage 13b of the other longitudinal part 13, terminate in or near the cavity 11.

To avoid the risk of raising the racks 4, 7 in an end position, it is ensured that the distance between the axis of rotation of the pinion 1 and these second passages 12b and 13b terminating in the cavity 11 is less than the minimal distance between this axis of rotation and the end of the first and/or second rack 4, 7.

When the cavity 11 is substantially circular, as shown in FIG. 2, the distance between the axis of rotation of the pinion 1 and the second passages 12b and 13b corresponds to the radius of the cavity 11.

The end position mentioned hereinabove corresponds to the position in which the first or the second racks 4, 7, by its longitudinal element 4, 7, is stopped at the level of the end of the opening 8, against the teeth 2 of the pinion 1.

The minimal distance in question corresponds to the sum of the radius of the pinion 1 and of the length L of the end part of the longitudinal element 4, 7, between the end of the opening 8 and the end of this longitudinal element 4, 7.

If a distinction is made in the longitudinal element 4, 7, constituting a rack 4, 7, a first part in which is formed from the opening 8, thus a first part recessed, and a second full part between the end of the opening 8 and the end of the longitudinal element 4, 7, the length L corresponds to the length of the full end part of the longitudinal element 4, 7.

Accordingly, the minimal distance mentioned above corresponds to the sum of the radius of the pinion 1 and of the length L of the full end part of the longitudinal element 4, 7.

In the position in question hereinabove, if the distance between the axis of rotation of the pinion 1 and the second passages 12b, 13b is less than this minimal distance such as illustrated hereinabove, the end of the rack 4, 7 remains in the housing 3, guided through at least the second passage 12b, 13b. Accordingly, the rack 4, 7 remains in the plane of rotation of the pinion 1, and remains in its housing.

One or more studs 10, 21 can likewise be provided on the base of the housing 3, thus in this variant, on the base of the cavity 11.

The first 4 and the second 7 racks are then supported against these studs 10, 21. Accordingly, during translation, and despite the elastic deformation which they can undergo, as explained hereinabove, the racks 4, 7 are kept in the plane of rotation of the pinion 1, and do not move out of alignment.

In the event where these studs are present, the clearances jᵢ and j₂ such as presented hereinabove are limited to the distance between the external longitudinal edges of the racks 4, 7 and the respective ends of the studs 10, 21.

As a consequence, as explained hereinabove, the distance between the external longitudinal edges of the racks 4, 7 and of the respective ends of the studs 10, 21 must be greater than or equal to the least height of teeth, such as defined hereinabove.

As is evident from FIG. 3, the pinion 1 can be mounted on a support 15, preferably circular, which is then housed in the housing 3, thus in the cavity 11 in this variant.

Arranged peripherally to this support 15 are two deformable lateral branches 16, 18, preferably semi-circular, which play the role of temporary blocking means of the support 15, thus of the pinion 1, in the cavity 11 of the housing 3, thus in the housing 3.

These lateral branches 16, 18 cooperate, by way of respective pins 19, 20 placed substantially in their respective ends, with temporary blocking means 17, illustrated in FIG. 2, placed in the cavity 11 of the housing 3.

These temporary blocking means 17 in the housing 3 take the form of striae 17 distributed in a crown at the periphery of the cavity 11.

The aim of this cooperation of the temporary blocking means 16, 18, 19, 20 at the level of the support 15, with the temporary blocking means 17 at the level of the housing 3, is to prevent or limit free rotation of the pinion 1.

Accordingly, in the absence of a certain force of rotation imparted in one direction or the other to the pinion 1, the pin 19 and/or 20 of the lateral branch 16 and/or 18 of the support 15 of the pinion 1 remains blocked temporarily in one of the striae 17 of the crown of striae of the cavity 11 of the housing 3. The pinion 1 does therefore not commence rotation, and the rack 4 and/or 7 is stable.

To adjust the device, rotation must be imparted to the pinion 1, with a certain force, the effect of which is to impart this same rotation to the support 15 of the pinion. The pin 19 and/or 20 then withdraws from the stria 17 in which it was temporarily blocked, under the effect of elastic deformation of the lateral branch 16 and/or 18 which bears this pin 19 and/or 20.

If rotation continues, with at least this same force, the pin 19 and/or 20 penetrates successively into several striae 17 of the cavity 11 of the housing 3, by the return effect of the deformable lateral branch 16 and/or 18, but immediately comes out of these striae 17, in the manner of a latch.

The rotation is thus triggered, causing translation of the rack 4 and/or 7, until the force of rotation imparted to the pinion 1 diminishes below a certain threshold. Below this threshold, the pin 19 and/or 20 re-engages in one of the striae 17 of the crown of striae of the cavity 11 of the housing 3, but this time without coming back out, under the return effect of the deformable lateral branch 16 and/or 18. The pin 19 and/or 20 is again blocked temporarily, thus stabilising the rack 4 and/or 7.

In FIG. 4, the adjusting device is illustrated in an exploded view without the rack 4, 7.

By means of its support 15 the pinion 1 comes to lodge in the cavity 11 of the housing 3, free in rotation R about the axis A (within the limits of the temporary blocking means 16 to 20 mentioned hereinabove).

An adjusting thumb wheel 14 is mounted on the assembly, on the axis A, connected to the support 15 in rotation R by linking means 23, so as to facilitate the setting in rotation of the pinion 1.

The pinion 1, with or without support 15, can optionally be integrated directly into the adjusting thumb wheel 14. In this case, the pinion 1, or its support 15, has an upper part which acts as adjusting thumb wheel.

This thumb wheel 14 can constitute a type of closing cap of the housing 3, or itself be closed by an independent cap 22.

This figure likewise illustrates one of the longitudinal parts 13, with its first passage 13a, such as presented hereinabove in reference to FIG. 2.

Given the perspective, the second passage 13b of this longitudinal part 13, terminating in the cavity 11, is not illustrated. The same applies for the other longitudinal part 12 and its first and second passage 12a and 12b.

FIG. 5 illustrates a strap 6, constituting the adjustment means 6 utilised to adjust an adjustable dimension of an object, in particular, though not only, an object intended to be worn by a user such as a helmet, a shoe, an item of clothing or any accessory having such an adjustable dimension.

In the case of a helmet, these adjustment means 6, likewise known as “ring”, are fixed in principle inside the helmet by the central part 6a. The two end parts 6b and 6c are brought back on one another to form a closed loop, and by adjusting the perimeter of the loop, the helmet is adjusted to the size of the wearer.

One or both ends 6b, 6c are connected to the adjusting device of the invention, such as disclosed hereinabove in reference to FIGS. 1 to 4.

In precise terms, these ends 6b, 6c are connected to the racks 4 and 7. In the variant illustrated in FIG. 5, these ends 6b and 6c are combined with the racks 4 and 7.

Accordingly, these ends 6b and 6c of the adjustment means 6 reveal the two longitudinal elements 4 and 7, each provided with an opening (referenced 8 for the first longitudinal element 4, and not referenced for the second longitudinal element 7) such as described previously, and along at least one side 8a of which are arranged the rows of teeth 5 and 9.

By translation T, T′ of the racks 4, 7 such as explained hereinabove, such adjustment means 6, associated with an object of adjustable dimension, such as a helmet, adjust the dimension in question.

It can thus be a question for example of adjusting a helmet to the head of a user, or again a shoe to the foot or the calf of a user.

The adjustment means 6, such as a strap or a cable 6, can likewise be utilised autonomously, for example for tying up a set of objects to be kept together. The clamping diameter of the packet of objects to be formed is adjusted, by adjusting the perimeter of the loop formed by the strap 6.

The entire description hereinabove is given by way of example, and thus does not limit the invention.

In particular, the device of the invention has been presented hereinabove with two racks 4, 7, but can function just as well with a single rack, in one of the ends of the strap 6. The other end is then fixed to either the device itself, with no option for adjusting, or to the object, such as a helmet, the dimensions of which are to be adjusted.

Equally, in the event where the adjusting device has two racks 4, 7, it can be ensured that only one of these racks 4, 7, for example the first rack 7, is likely to deform elastically due to a single clearance in the housing 3 to this effect.

In this case, if the device is forced beyond the adjustment position, translation of the first rack 4 first stops. But as the second rack 7 remains meshed with the pinion 1, this second rack continues its translation. As a consequence, in the case of a strap forming a closed loop, with two racks in each end, the first rack 4 starts to move back, that is, goes into inverse translation. The aim of this is to shift the device, without modifying the adjustment (example, head girth for a helmet).

All the same, especially for an application of adjusting strap or ring type of the head girth in a helmet, it is preferred that each of the two racks is able to deform due to appropriate clearance, to prevent shifting of the device mentioned hereinabove. In fact, if such shifting does occur, the adjusting device reaches a position which is not adapted (for example, on the front of the head instead of being behind or to the side), and the user has to reposition it to the right position for later use.

1. An adjusting device suitable for adjusting at least one dimension of an object, such as an object intended to be worn by a user, such as a shoe, an item of clothing, a helmet or an accessory, said device comprising a pinion provided with several first teeth of a first height, said pinion being housed free in rotation about an axis in a housing, and at least one first rack provided with at least one row of several second teeth of a second height, said first rack being slid free in translation into said housing, said second teeth cooperating with said first teeth such that rotation of said pinion about the axis causes translation of said first rack,
wherein
said first rack is deformable elastically, such that when a force acts on said first rack in the direction opposite the direction of said translation during rotation of the pinion, said first rack undergoes elastic deformation,
said housing leaves a clearance for the first rack, in the plane of rotation of the pinion and perpendicular to the direction of translation, said clearance being at least equal to the least of said first and second heights respectively of said first and second teeth, such that when the first rack undergoes said elastic deformation, that of the second teeth in cooperation with the first teeth of the pinion disengages from these said first teeth.

2. The device as claimed in claim 1, comprising a second rack provided with at least one row of several third teeth of a third height, said second rack being slid free in translation opposite the translation in said housing, said third teeth cooperating with said first teeth such that the rotation of said pinion about the axis causes translation of said second rack, this said second rack being deformable elastically, such that when a force acts on this second rack in the direction opposite the direction of said translation during rotation of the pinion, this second rack undergoes elastic deformation, the housing leaving clearance for the second rack, in the plane of rotation of the pinion and perpendicular to the direction of translation, said clearance being at least equal to the least of said first and third heights respectively of said first and third teeth, such that when the second rack undergoes said elastic deformation, that of the third teeth in cooperation with the first teeth of the pinion disengages from these said first teeth.

3. The device as claimed in claim 1, wherein the first and/or second rack is in the form of a longitudinal element provided with an opening according to its longitudinal direction, said opening being delimited by a first side, the row of second and/or third teeth being placed along said first side.

4. The device as claimed in claim 3 and having a first and a second rack, wherein the first side of the opening of the longitudinal element forming said first rack, along which is placed the row of second teeth, is opposite the first side of the opening of the longitudinal element forming said second rack, along which is placed the row of third teeth.

5. The device as claimed in claim 1, wherein the housing comprises a cavity centred on the axis of rotation and intended to receive the pinion, and two longitudinal parts on either side of said cavity and intended to guide the first and/or second rack in translation, said longitudinal parts each having a first and a second passage for the passage of said first and/or second rack, said first passages being placed at a distance from said cavity, and said second passages terminating in said circular cavity, the distance between said axis of rotation and said second passages being less than the minimal distance between this said axis of rotation and the end of said first and/or second rack.

6. The device as claimed in claim 1, wherein the base of the housing has at least one stud against which the first and/or second rack rests, so as to keep said first and/or second rack in the plane of rotation of the pinion.

7. The device as claimed in claim 1, comprising a thumb wheel connected in rotation to the pinion by linking means and intended to impart rotation to said pinion.

8. The device as claimed in claim 7, wherein the pinion is integrated into the thumb wheel.

9. The device as claimed in claim 7, wherein the thumb wheel forms a closing cap of the housing.

10. The device as claimed in claim 1, wherein the pinion is mounted on a support which then lodges in the housing.

11. The device as claimed in claim 10, wherein the support is provided with a temporary blocking structure which cooperates with a temporary blocking structure in the housing, so as to prevent free rotation of the pinion.

12. The device as claimed in claim 11, wherein the temporary blocking structure of the support comprises at least one deformable and preferably semi-circular lateral branch provided with a pin, and the temporary blocking structure in the housing comprises striae arranged in a crown and which cooperate with said pin.

13. An object having at least one adjustable dimension by means of an adjustment mechanism, wherein the adjustment mechanism is connected to or comprises an adjusting device as claimed in claim 1, wherein translation of the first and/or second rack causes adjustment of said adjustable dimension of the object.

14. The object as claimed in claim 13, wherein the adjustment mechanism comprises a strap or a cable connected to the object and whereof at least one first end is connected to or constitutes the first or second rack of the adjusting device.

15. The object as claimed in claim 14, wherein a second end of the strap or of the cable is connected to or constitutes the other of the first or second racks of the adjusting device.

16. The object as claimed in claim 13, wherein the object is intended to be worn by a user, such as a helmet, a shoe, an item of clothing or an accessory, the adjustment adapting the adjustable dimension of said object to the dimension or dimensions of the part of the body of the user intended to wear said object.

17. The object as claimed in claim 16, wherein the object is intended to be worn on the head of a user, such as a helmet, the adjustable dimension being the head girth.

18. The object as claimed in claim 17, wherein the object is intended to be worn on the foot of a user, such as a shoe, the adjustable dimension being the ankle joint or the calf girth.

19. A strap or clamping cable for forming a closed loop and having a first and a second end wherein the strap is provided with an adjusting device as claimed in claim 1, wherein its first and/or its second end is connected to or constitutes the first and/or second rack of said adjusting device, the translation of the first and/or second rack causing adjustment of the perimeter of said loop.
